(19) United States
(12) Patent Application Publication
(10) Pub. No.: US 2026/0287097 A1
(43) Pub. Date: Sep. 24, 2026

(54) COMPRESSION FITTINGS AND SYSTEMS, KITS, AND METHODS INCORPORATING THE SAME

(71) Applicant: TITEFLEX CORPORATION, Springfield, MA (US)

(72) Inventors: Eric Hall, Castalian Springs, TN (US); Brandon Carter, Lafayette, TN (US); Connor Welcome, Portland, TN (US); Paul Beshear, Greenbrier, TN (US)

(73) Assignee: TITEFLEX CORPORATION, Springfield, MA (US)

(21) Appl. No.: 19/563,366

(22) Filed: Mar. 11, 2026

Related U.S. Application Data
(60) Provisional application No. 63/775,396, filed on Mar. 21, 2025.

(51) Int. Cl. F16L 21/06

(52) U.S. Cl. CPC F16L 21/065

(57) ABSTRACT

One aspect of the invention provides a compression fitting including: a nipple, a ferrule, a first clamshell member, a second clamshell member, and a retaining ring. The nipple includes: an annular groove; a longitudinal passage; and an engagement feature. The ferrule is sized to fit over the nipple and compress a tubing end between the ferrule and the nipple, such that the nipple is configured and adapted for insertion within the ferrule, the ferrule having a complementary inner diameter. The retaining ring is seated within the annular groove of the nipple and engaged with complementary geometry of the inner diameter of the ferrule to distally retain the ferrule such that the first clamshell member and the second clamshell member sit radially over, but not within, the annular groove of the nipple.

### CROSS-REFERENCE TO RELATED APPLICATION

This application claims the benefit of priority under 35 U.S.C. § 119(e) to U.S. Provisional Patent Application Ser. No. 63/775,396, filed Mar. 21, 2025. The entire content of this application is hereby incorporated by reference herein.

### BACKGROUND OF THE INVENTION

Multilayer composite pipes are designed and used to convey liquids, primarily water, for applications such as in floor heating, radiator heating, and water supply.

### SUMMARY

One aspect of the invention provides a compression fitting including: a nipple, a ferrule, a first clamshell member, a second clamshell member, and a retaining ring. The nipple includes: an annular groove; a longitudinal passage; and an engagement feature. The ferrule is sized to fit over the nipple and compress a tubing end between the ferrule and the nipple, such that the nipple is configured and adapted for insertion within the ferrule, the ferrule having a complementary inner diameter. The retaining ring is seated within the annular groove of the nipple and engaged with complementary geometry of the inner diameter of the ferrule to distally retain the ferrule such that the first clamshell member and the second clamshell member sit radially over, but not within, the annular groove of the nipple. The first clamshell member and the second clamshell member are adapted and configured to: engage with complementary geometry of the engagement feature of the nipple to resist at least distal movement; and radially compress the ferrule to cause the ferrule to compress the tubing end against the nipple and form a gas-tight seal with the tubing end.

This aspect of the invention can have a variety of embodiments. The first clamshell member and the second clamshell member can be hinged to each other. The first clamshell member and the second clamshell member can be coupled by screws. The nipple can further include one or more selected from the group consisting of: one or more annular grooves, one or more O-rings, and one or more barbs.

Another aspect of the invention provides a a method for a compression fitting. The method includes: providing a tube having a cut end; mating the nipple of the compression fitting of as described herein with the cut end of the tube; placing the ferrule of the compression fitting over the cut end of the tube; placing the clamshell members of the compression fitting over the ferrule; and compressing the clamshell members and, as a result, the ferrule and the tubing, thereby forming a gas-tight seal between the fitting and tubing.

### BRIEF DESCRIPTION OF THE DRAWINGS

FIGS. 1A-1C are diagrammatic illustrations of a compression fitting and its components, according to one or more embodiments.

FIG. 2 is flow diagram of a method for installing a tubing onto the compression fitting of FIGS. 1A-1C, according to one or more embodiments.

FIG. 3 depicts a typical heating, ventilation, air-conditioning, and refrigeration (HVACR) system, within which one or more embodiments of the invention are particularly useful.

### DETAILED DESCRIPTIONS

Aspects of the invention provide fittings and systems, kits, and methods incorporating the same. The fittings described herein advantageously allow for a quicker-installing fitting that a user can install or uninstall for use at any point after manufacture.

Embodiments of the fitting assembly described herein can advantageously allow for sealing between a fitting and a length of tubing without the need to rotate a portion of the fitting after insertion of the tubing. Such rotation (e.g., with a wrench, a crowfoot wrench, a torque wrench, pliers, tongue-and-groove pliers, and the like) can be particularly challenging in tight spaces (e.g., attics, closets, and the like) where it may be difficult to rotate a tool requiring sufficient length to generate sufficient torque. In contrast, compact ¼″-inch hex-shank impact drivers may be easier to place lateral to the fitting as discussed herein.

The fitting assembly described herein can be designed to apply tightening force in the same direction as compression, rather than perpendicular, ensuring even pressure distribution along a tube and reducing stress concentrations at the mating point between a cut end of a tubing or tube. The fitting assembly can include a split bushing with ribbed engagement surfaces that interlock with complementary features of the barbs of a nipple of a fitting, ensuring strong pipe retention while preventing axial movement. The fitting assembly can include O-rings to provide a fluid-tight seal and compensate for misalignment. A locking mechanism between the barb and clamshell maintains structural integrity, while an optional hinged clamshell design simplifies installation. The fitting assembly can be secured using one or two bolts. In some implementations, the fitting can be forged from brass to offer high corrosion resistance and durability, with stainless steel, coated steel, aluminum alloys, and the like as alternative materials for enhanced strength and chemical resistance.

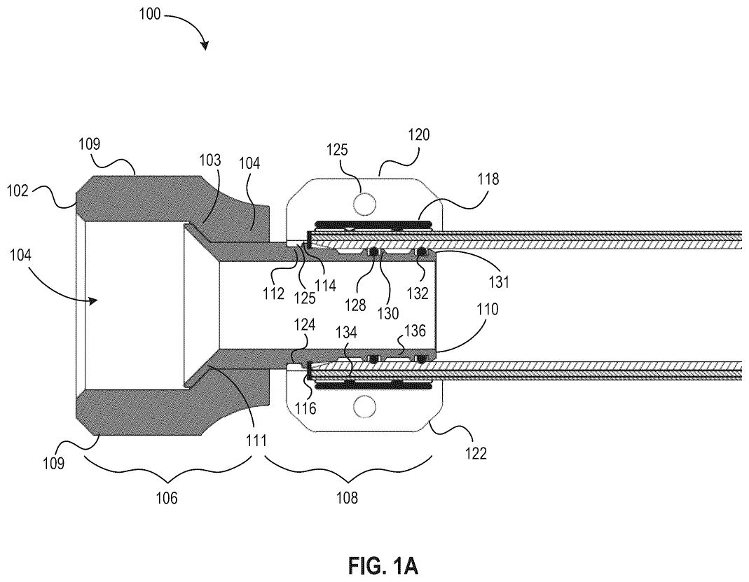

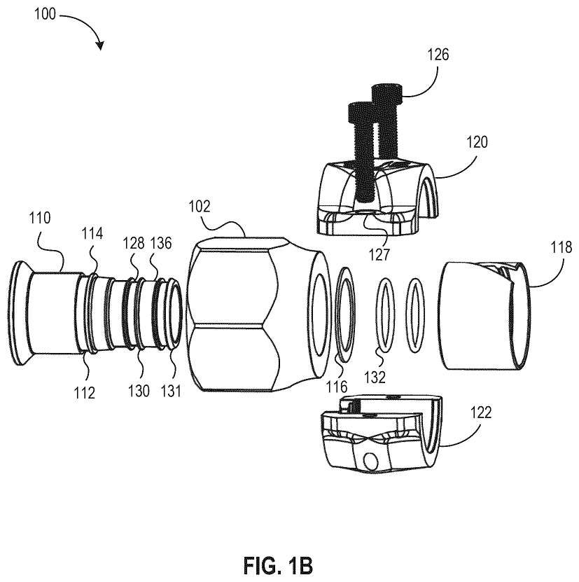

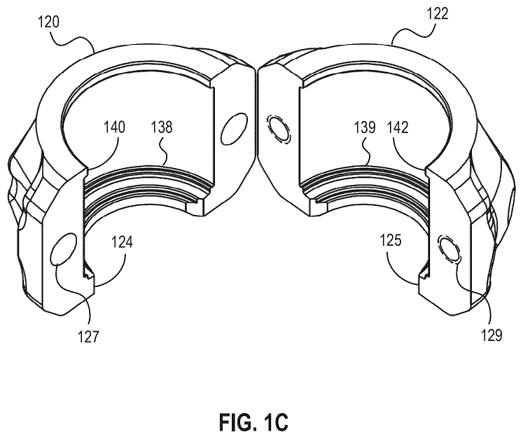

Referring to FIGS. 1A-1C, a fitting 100 can include a body 102 defining a central bore 104 allowing fluids (e.g., a refrigerant) to flow through from a proximal end 106 to a distal end 108. In some implementations, the body 102 can be or include a swivel nut. The body 102 can include a threaded region adapted and configured to be installed with onto a complementary threaded device (not shown in FIGS. 1A-1C). In some cases, the threaded region can include female threads, male threads, or other geometries for coupling, and can be sized to mate with common pipe sizes (e.g., ½″, ¾″, 1″, 1¼ “, 1½”, 2″ Nominal Pipe Size). The body 102 can have wrench flats 109 such as a hexagonal region on an outer surface of the body 102 such that the flats 109 allow for tightening of the threaded region into a complementary device (e.g., a flare fitting, a male flare fitting, a tubing) using a wrench, pliers, or other tool. In some implementations, the body 102 can include a radially inner distal stop shoulder 103.

The body 102 can serve as a housing such that a nipple 110 can be inserted from the proximal end 106 towards to the distal end 108. The nipple 110 can include a radially outward stop shoulder 111 at the proximal end 106, which can be resisted by a radially inner distal stop shoulder 103 of the body 102, such that the nipple 110 does not further extend further towards the distal end 108 and out of the body 102. The radially inner distal stop shoulder 103 can serve as a structural stop for the insertion of the nipple 110 and can provide support, stability, and alignment with the coupling of the body 102 and/or the nipple 110 with a cut end of a tubing.

In some implementations, a gasket (not shown in FIGS. 1A-1C can be inserted to plug the central bore 104 inside the body 102 and/or the nipple 110. In some implementations, the gasket can include any seal configured to fill the area defined by the radially outer stop shoulder 111 of the nipple 110 to form a gas-tight and/or liquid-tight seal against an inner sealing surface of the radially inner distal stop shoulder 103.

The proximal end 106 can have the features described herein or can have a different mating system. For example, the proximal end can have an annular inner or outer surface adapted and configured for coupling (e.g., to HVAC/R equipment such as a compressor or a condenser) using brazing, soldering, or an annular press. In another example, at the proximal end 106 the body 102 can have a conical profile and/or a threaded nut adapted and configured to engage with a complementary flared fitting (e.g., as described in U.S. Provisional Patent Application Ser. Nos. 63/725,358 and 63/725,389, both filed Nov. 26, 2024). In some cases, the other sealing arrangements disclosed in those applications can also be used (e.g., to allow for sealing against another length of tubing).

The distal end 108 can include the nipple 110 including an engagement feature, e.g., a recess 112 and/or boss 114. Recess(es) 112 and/or boss(es) 114 can be annular or discrete. At the distal end 108, the nipple 110 can extend outwards and mechanically couple to the cut end of the tubing. Fluids can be transferred through the central bore 104, the nipple 110, and the cut end of the tubing.

The cut end of tubing can be placed over the nipple 110 (or the nipple 110 can be placed within the cut end of tubing). A stop shoulder 116 (e.g., a split bushing or press-fit member applied after assembly of the nipple 110 with the body 102) or other depth gauge can provide positive feedback regarding sufficient engagement. After engagement of the tubing relative to the nipple 110, a ferrule 118 can be placed over the tubing. The ferrule 118 can be a split or two-piece ferrule (e.g., having two identical semi-annular halves). In the case of a split ferrule, the ferrule 118 can be placed over the tubing prior to engagement with the nipple 110, then slid proximally to lie radially over the nipple 110. The ferrule 118 can be sized to fit over the nipple 110 and compress a tubing end between the ferrule 118 and the nipple 110.

A first clamshell member 120 and a second clamshell member 122 can then be placed over the ferrule 118 and the nipple 110. Each of the clamshell members 120, 122 can include complementary engagement features 124, 125 to engage with engagement feature(s), e.g., recess 112 and/or boss 114 of nipple 110. For example, each of the complementary engagement features 124, 125 can be a complementary projection that can include an inner boss or annular shoulder that sit within recess 112 and against boss 114 to resist at least distal movement. Interaction with recess 112 also provides radial axial alignment to promote interactions between the geometries of nipple 110 and ferrule 118 as discussed herein.

In some cases, the ferrule 118 can include one or more complementary projections 134 (e.g., annular, points, and the like) on a radially-inner surface of the ferrule 118 that axially align with the one or more annular grooves 136 to result in radial deflection of the tubing impinged between the complementary features.

Clamshell members 120, 122 can be drawn radially together to compress the ferrule 118 against the tubing and the nipple 110 to seal and retain the tubing. In some embodiments, the clamshell members 120, 122 can include bores 127 to receive screws or bolts 126. In some embodiments, the second clamshell member 122 includes female threads 129 to engage with screws. In other embodiments, one or more nuts are received within one of the clamshell members 120, 122.

Screws or bolts 126 can have a variety of drive geometries including hexagonal, pyramidal, slotted, cross, cruciform, Phillips, Frearson, French recess, JIS B 1012, Mortorq, Pozidriv PV, Supadriv PZ, Torq-set, Phillips/slotted, external polygon, square, pentagonal, hexagonal, 12-point, internal polygon, triangle, Robertson, hexagonal (Allen), double square, triple square, 12-spline flange, double hex, Torx, Torx Plus, Polydrive, three-pointed, tri-point, tri-groove, tri-wing, Bristol, Quadrex, Pentalobe, spanner (pig nose), and the like.

Screws or bolts 126 can have a variety of head geometries including a pan, button, dome, round, mushroom, truss, countersunk, flat, oval, raided, bugle, cheese, fillister, or flanged. In some embodiments, the head includes a flange that is substantially perpendicular to the shaft of the screw or bolt 126.

Compression can alternatively be provided by rivets (e.g., blind rivets), crimping presses, and the like.

Clamshell members 120, 122 can be hinged to each other such that one or more screws are only required on a single side.

In some embodiments, the nipple 110 and/or ferrule 118 can include one or more features adapted and configured to promote sealing and/or resist distal pull-off. For example, the nipple 110 can include annular grooves 128, barbs/ridges 130, and the like. The annular grooves 128 can be along a radially outer surface of the nipple 110, to resist pullback of the cut end of the tubing from the nipple 110. In some cases, the nipple 110 can have a tapered, beveled, or rounded end 131 to facilitate medial insertion of the nipple 110 into the cut end of the tubing (which may be deformed from cutting). In some implementations, the barbs/ridges 130 can provide mechanical retention for the cut end of the tubing and can engage with the ferrule 118 and the clamshell members 120, 122 to provide the mechanical retention.

In some implementations, retaining rings 132 can be seated within the annular grooves 128 of the nipple 110 and engaged with the cut end of the tube to distally retain the cut end of the tube and form a gas-tight seal. In some cases, the retaining rings 132 can be split bushings, O-rings, or the like. In some cases, the retaining rings 132 can deform or stretch to engage prior to seating in the annular grooves 128. The retaining rings 132 can be configured to create a fluid-tight seal to prevent leaks. The retaining rings 132 can be seated within the annular grooves 128 and engaged with complementary geometry of the inner diameter of the ferrule 118 to distally retain the ferrule 118 such that the clamshell member 120, 122 can sit radially over, but not within, the annular grooves 128 of the nipple 110.

In some embodiments, the ferrule 118 can include on one or more complementary projections 134 (e.g., annular, points, and the like) on a radially inner surface of the ferrule 118 that axially align with the one or more annular grooves 136 to result in radial deflection of the tubing. In some implementations, the retaining rings 132 can be seated within the annular grooves 128 and engaged with complementary geometry of the ferrule 118 such that ferrule 118 sits radially over, but not within the annular grooves 128 of the nipple 110.

In some implementations, the cut end of the tubing can have a complementary inner diameter to enable insertion of the nipple 110 at the distal end 108 into the cut end of the tubing. For instance, the deformed cut end of the tubing can then provide a grip onto the nipple 110 and can be prevented from decoupling due to the radial deflection of the tube and the inner radial shoulders 134 of the ferrule 118 and/or the annular grooves 136. The nipple 110 at the distal end 108 can also have a tapered, beveled, or rounded end to facilitate insertion within the cut end of the tubing.

The clamshell members 120, 122 can include one or more alignment members, e.g., annular grooves 138, 139 and/or stop shoulders 140, 142 to axially align ferrule 118, e.g., to promote alignment between inner features of ferrule 118 and outer features of nipple 110. In some implementations, the annular grooves 138, 139 of the clamshell members 120, 122, respectively, can be a define complementary area such that the complementary area engages with and around the ferrule 118 to secure the ferrule 118 around the cut end of the tubing and/or the nipple 110 and/or prevent leaks.

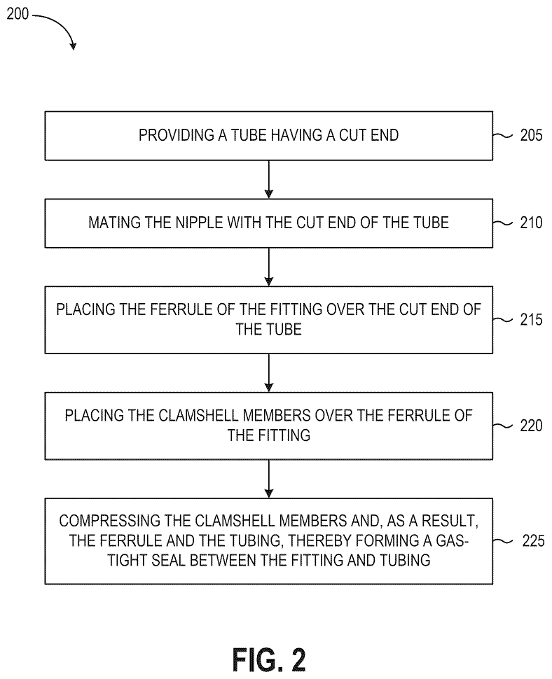

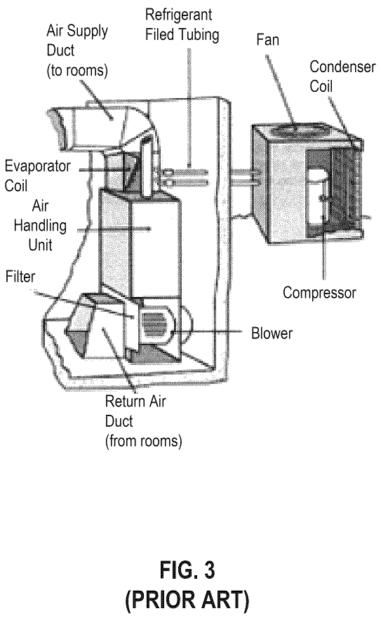

FIG. 2 is flow diagram of a method 200 for installing a tubing onto the compression fitting of FIG. 1, according to one or more embodiments. In some implementations, the method 200 can include a method for installing a cut end of a tube over a fitting.

At 205, the method 200 includes providing a tube having a cut end. The tube can include a composite HVAC/R line set tubing as sold under the PYTHON™ trademark from Titeflex Corporation of Springfield, Massachusetts and/or as described in U.S. Patent Application Publication Nos. US 2020/0400251, US 2021/0207744, US 2022/0032571, and US 2024/0133599. The line set can be cut to lengths in the field using tools such as a tubing cutter and reamed to remove burrs and swarf.

At 210, the method 200 includes mating the nipple with the cut end of the tube. The method 200 can be performed at the field or any place/location following the manufacture of the fitting.

At 215, the method 200 includes placing the ferrule of the compression fitting over the cut end of the tube.

At 220, the method 200 includes placing the clamshell members over the ferrule of the fitting. The clamshell members can engage with one or more engagement features on the nipple to facilitate axial alignment.

At 225, the method 200 includes compressing the clamshell members and, as a result, the ferrule and the tubing, thereby forming a gas-tight seal between the compressing fitting and the tubing.

### EQUIVALENTS

Although preferred embodiments of the invention have been described using specific terms, such description is for illustrative purposes only, and it is to be understood that changes and variations may be made without departing from the spirit or scope of the following claims.

### INCORPORATION BY REFERENCE

The entire contents of all patents, published patent applications, and other references cited herein are hereby expressly incorporated herein in their entireties by reference

1. A compression fitting comprising:
a nipple comprising:
an annular groove;
a longitudinal passage; and
an engagement feature;
a ferrule sized to fit over the nipple and compress a tubing end between the ferrule and the nipple, such that the nipple is configured and adapted for insertion within the ferrule, the ferrule having a complementary inner diameter;
a first clamshell member;
a second clamshell member; and
a retaining ring seated within the annular groove of the nipple and engaged with complementary geometry of the inner diameter of the ferrule to distally retain the ferrule such that the first clamshell member and the second clamshell member sit radially over, but not within, the annular groove of the nipple;
wherein the first clamshell member and the second clamshell member are adapted and configured to:
engage with complementary geometry of the engagement feature of the nipple to resist at least distal movement; and
radially compress the ferrule to cause the ferrule to compress the tubing end against the nipple and form a gas-tight seal with the tubing end.

2. The compression fitting of claim 1, wherein the first clamshell member and the second clamshell member are hinged to each other.

3. The compression fitting of claim 1, wherein the first clamshell member and the second clamshell member are coupled by screws.

4. The compression fitting of claim 1, wherein the nipple further comprises one or more selected from the group consisting of: one or more annular grooves, one or more O-rings, and one or more barbs.

5. A method for a compression fitting, the method comprising:
providing a tube having a cut end;
mating the nipple of the compression fitting of claim 1 with the cut end of the tube;
placing the ferrule of the compression fitting over the cut end of the tube;
placing the clamshell members of the compression fitting over the ferrule; and
compressing the clamshell members and, as a result, the ferrule and the tubing, thereby forming a gas-tight seal between the fitting and tubing.
